(19) United States
(12) Patent Application Publication
(10) Pub. No.: US 2004/0106400 A1
(43) Pub. Date: Jun. 3, 2004

(54) System for monitoring mobile communication performance

(75) Inventors: Hyuk Joon Woo, Gyeonggi-do (KR); Hyun-Tae Kim, Gyeonggi-do (KR); Jae-Young Park, Gyeonggi-do (KR)

Correspondence Address: McGuire Woods, Suite 1800, 1750 Tysons Boulevard, McLean, VA, 22102-4215, US

(73) Assignee: Willtek Corporation

(21) Appl. No.: 10/417,126

(22) Filed: Apr. 17, 2003

(30) Foreign Application Priority Data
Apr. 18, 2002 (KR) 10-2002-0021251

(51) Int. Cl. H04M 3/00

(52) U.S. Cl. 455/423; 455/425; 455/557

(57) ABSTRACT

In a monitoring system for testing a performance of a plurality of mobile communications terminals and networks, the monitoring system has a main body coupled with a plurality of mobile communications terminals through cables for transmitting DM data and data stream by using serial and USB interfacing with the mobile communications terminals, memory means for storing data collected by the main body, which is coupled with the main body and a data control unit for conducting an application software preinstalled therein to preset an operation schedule.

### FIELD OF THE INVENTION

The present invention relates to a system for monitoring performance of various communications terminals for use in a mobile communications networks.

### BACKGROUND OF THE INVENTION

In a mobile communications system such as a code division multiple access (CDMA) system, there is utilized a performance evaluation equipment to evaluate the performance of a mobile communications terminal and its networks. A prior CDMA terminal adopts a serial interface for communications with an external equipment through a carkit that is usually installed or attached thereto. Through the serial interface, the prior CDMA terminal transmits diagnostic monitor (DM) data including measured parameters such as Mobile Assistant Handoff metrics and a full air interface message. Therefore, a prior monitoring system utilizes the DM data received from the mobile communications terminal through a serial interface thereof for testing a CDMA terminals and networks performance. The prior monitoring system carries out terminal evaluation and compliance testing such as a call test and a short message service (SMS) test.

However, at present, a mobile communications terminal adopts various types of interfaces such as a serial interface, a universal serial bus (USB) interface, an Ethernet interface or a wireless interface for forwarding data to an external process. Since various types of interfaces are used in the mobile communications terminals, various types of apparatus for monitoring and analyzing a performance of the respective mobile communications terminals are required, which can accommodate the various types of interfaces.

### SUMMARY OF THE INVENTION

It is, therefore, an object of the present invention to provide a system for monitoring a mobile communications performance, wherein the monitoring of a mobile communications terminal having various interface types can be performed without using other corresponding main body.

In accordance with a preferred embodiment of the present invention, there is provided a monitoring system for testing a performance of a plurality of mobile communications terminals in networks environment, wherein the monitoring system includes a plurality of mobile communications terminals for outputting diagnostic monitor (DM) data and data stream; a main body coupled with a plurality of mobile communications terminals through cables for receiving DM data and data stream from the mobile communications terminals by using a serial interface and a USB interface and modifying them to a specific data format; memory means for storing the transmitted-data of the main body, which is coupled with the main body; and a data control unit for conducting an application software preinstalled therein to preset a test plan including instructions for collecting the DM data and the data stream at the plurality of mobile communications terminals.

### BRIEF DESCRIPTION OF THE DRAWINGS

The above and other objects and features of the present invention will become apparent from the following description of preferred embodiments given in conjunction with the accompanying drawings, in which:

FIG. 1 illustrates a block diagram showing a structure of a monitoring system in accordance with a preferred embodiment of the present invention;

FIG. 2 shows a main body of the monitoring system shown in FIG. 1;

FIG. 3 describes a block diagram of a structure of a monitoring system in accordance with another preferred embodiment of the present invention; and

FIG. 4 offers a block diagram of a structure of a monitoring system in accordance with another preferred embodiment of the present invention.

### DETAILED DESCRIPTION OF THE PREFERRED EMBODIMENTS

The preferred embodiments of the present invention will now be described in detail with reference to the accompanying drawings.

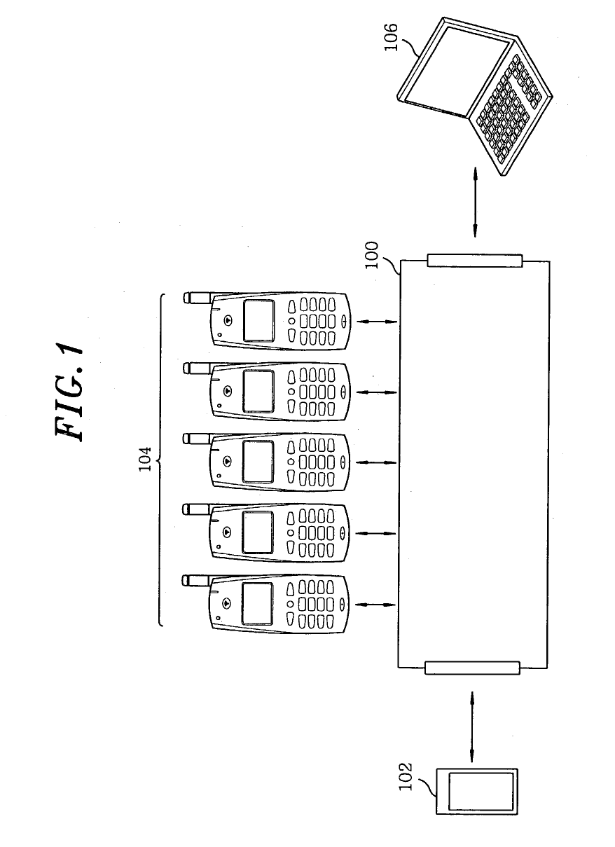

FIG. 1 illustrates a block diagram showing a structure of the monitoring system in accordance with a preferred embodiment of the present invention, having a main body 100, a memory device 102, five mobile communications terminals 104 and a data control unit (DCU) 106.

The main body 100 is coupled with the DCU 106 through a cable for interfacing with an application software preinstalled in the DCU 106 and coupled with the mobile communications terminal 104 through a cable.

The mobile communications terminals 104 adopt various types of interfaces for output of parameter data. The parameter data including DM data and data stream are transmitted to the main body 100 through a serial interface and a USB interfacing. The DM data is always outputted when the mobile communications terminals are in power-on state, representing a network environment of the mobile communications terminals and networks.

The memory device 102 stores temporarily data collected at the mobile communications terminal when a large amount of data is transmitted to the main body 100 and there is need to store the collected data for further analysis. The memory device 102 may be implemented by a flash memory card, which is attached in a slot type.

The data control unit has specific application software previously installed therein and a user can configure the setting thereof for monitoring of the mobile communications terminals and networks status. And also, the specific application software can display a result of the monitoring and analyzing in a predetermined format.

Additionally, a temperature sensor (not shown) for checking a temperature rise in the main body 100 can be added to activate an inner cooling fan against overheating thereof. Further, a speaker (not shown) can be added to output an audio message for enabling the system user to know a present status of the main body 100.

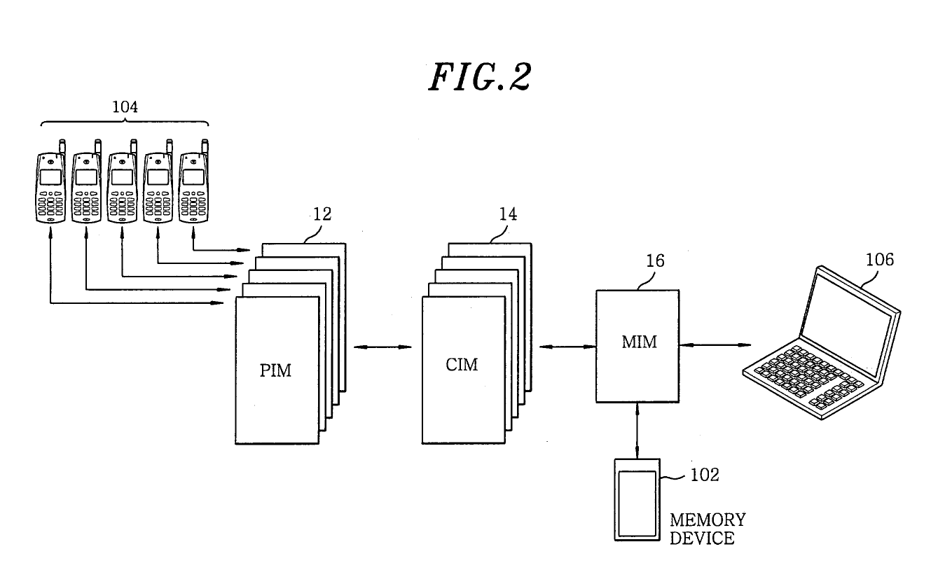

FIG. 2 shows a block diagram of the main body 100 of FIG. 1 in detail. The main body 100 includes a main interface module (MIM) 16, control interface modules (CIMS) 14 and phone interface modules (PIMs) 12.

The system user uses the application software to set a specific test plan to be performed and corresponding instructions of the test plan are transmitted from the DCU 106 to the main body 100. At the main body 100, the MIM 16 receives the instructions and distributes them to the corresponding CIMs 14, respectively. After receiving the specific instruction from the MIM 16, the respective CIMs 14 activate the corresponding mobile communications terminals 104 through the corresponding PIMs 12 and then the respective instructions are sent to the corresponding mobile communications terminals 104.

Then, the DM data or data stream corresponding to the inputted instruction are outputted from the mobile communications terminals 104 and transmitted to the PIMs 12 after specific time interval, which is set in the DCU 106. Herein, not only the DM data but also the data stream are outputted from the mobile communications terminals 104 when the mobile communications terminals 104 provide a data communication service. The PIMs 12 play a role for adjusting the processing speed between the mobile communications terminals 104 and the CIMs 14 since the CIMs 14 process the transmitted data at a speed relatively higher than that in the mobile communications terminals 104. In the CIMs 14, the transmitted data are sorted and processed to match with a specific format that is suitable for analyzing at the DCU 106. The processed data in the CIMs 14 are transmitted to the MIM 16 afterward.

The MIM 16 receives and transmits the collected data to the memory device 102 for storing if the amount of the collected data is too large to process at a time in the DCU 106; and if otherwise, transmits the collected data directly to the DCU 106 such that the data can be analyzed in real time by employing the application software.

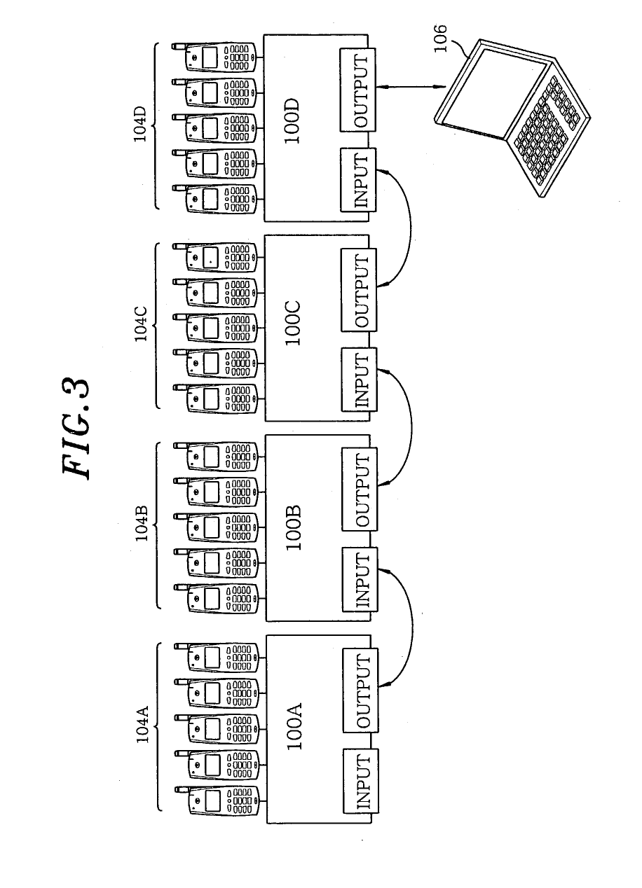

FIG. 3 describes a block diagram of a structure of a monitoring system in accordance with another preferred embodiment of the present invention.

As described in the FIG. 3, each of main bodies 100A, 100B, 100C and 100D includes four mobile communications terminal sets 104A, 104B, 104C and 104D, each of which has five mobile communications terminals and therefore twenty terminals can be used for monitoring in such a system. Each of the main bodies 100A, 100B, 100C and 100D has a hub module in the CIMs 14 therein and are coupled with each other for enabling communications between CIMs 14 therein.

And also, each of the main bodies 100A, 100B, 100C and 100D has an output port and an input port at the exterior side thereof. The output port is used for interfacing with the DCU 106 and the input port is used for interconnection between the main bodies 100A, 100B, 100C and 100D. By using the input and the output port, the four main bodies 100A, 100B, 100C and 100D can be connected in series. That is, the output port of 100A is coupled to the input port of 100B, the output port of 100B is coupled to the input port of 100C and the output port of 100C is coupled to the input port of 100D. Through these connections, the collected data at the respective main bodies 100A, 100B and 100C are assembled with the data collected in the main body 100D and transmitted to the DCU 106 through a connection between the output port of 100D and the DCU 106.

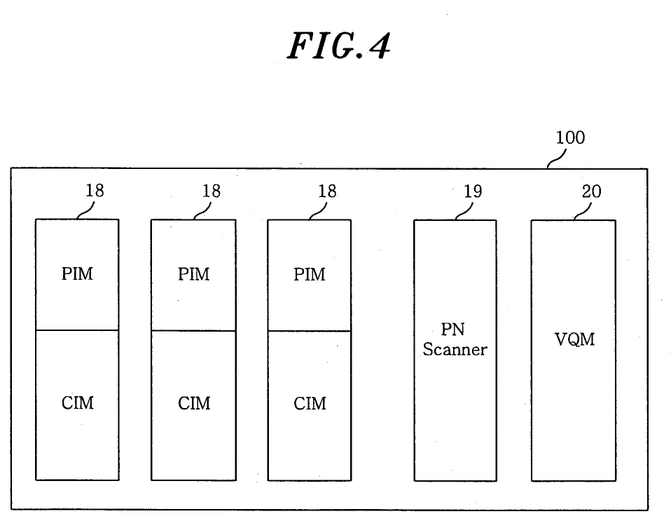

FIG. 4 offers a block diagram of a structure of a main body in accordance with another preferred embodiment of the present invention, wherein a pseudo noise (PN) scanner module 19 and a voice quality module (VQM) 20 are installed therein. The PN scanner 19 and the VQM 20 can be installed by a card inserting in the main body 100. Therefore, the monitoring system can conduct not only a basic DM or data monitoring and analysis but also a PN scanning or a VQM measuring in one main body at the same time.

Further, it should be noted that the above-described embodiments of the present invention could be applied to CDMA-2000 1× service which is provided at present and further to high speed wireless data transmission service, such as, a CDMA-2000 1× evolution-data only (1×EV-DO), a wideband CDMA (W-CDMA) and a third generation mobile communications such as an international mobile telecommunications 2000 (IMT-2000) which will be provided in due course for monitoring a quality of voice and wireless data communications. For an example, when the monitoring system in accordance with the present invention is applied to the mobile communications terminal providing an IMT-2000 service, it is enough to modify a row of CIM and PIM 18 for such a system to be applicable for monitoring of the performance thereof.

While the invention has been shown and described with respect to the preferred embodiments, it will be understood by those skilled in the art that various changes and modifications may be made without departing from the spirit and scope of the invention as defined in the following claims.

What is claimed is:

1. A monitoring system for testing a performance of a plurality of mobile communications terminals in networks environment, the monitoring system comprising:
a plurality of mobile communications terminals for outputting diagnostic monitor (DM) data and data stream;
a main body coupled with a plurality of mobile communications terminals through cables for receiving the DM data and data stream from the mobile communications terminals by using a serial interface or a USB interface and modifying them to a specific data format;
memory means for storing the modified data of the main body, which is coupled with the main body; and
a data control unit for conducting an application software preinstalled therein to preset a test plan including instructions for collecting the DM data and the data stream at the plurality of mobile communications terminals.

2. The system of claim 1, wherein the main body includes
a main interface module (MIM) for transmitting instructions provided from the data control unit to corresponding CIMs (control interface modules), transmitting the DM data and data stream collected at the mobile communications terminals to the data control unit and also storing the collected DM data and data stream in the memory means;
the CIMs for transmitting the respective instructions provided from the MIM to corresponding phone interface modules (PIMs), processing the DM data and the data stream transmitted from the PIMs and transmitting to the MIM; and
the PIMs for transmitting the respective instructions provided from the CIMs and transmitting the DM data and the data stream from the mobile communications terminals to the CIMs.

3. The system of claim 2, wherein the main body further includes a pseudo noise scanner and a voice quality module.

4. The system of claim 3, wherein the pseudo noise scanner and the voice quality module is installed by card insertion.

5. The system of claim 1, wherein the memory means is PCMCIA flash memory.

6. The system of claim 1, wherein the main body further includes an input port for connecting to other main bodies-in series and an output port for coupling with the data control unit.

7. The system of claim 1, wherein the plurality of mobile communications terminals provides the one service selected from the group consisting of CDMA-2000 1×, CDMA-2000 1×EV-DO, W-CDMA and IMT-2000.
